(19) United States
(12) Patent Application Publication
(10) Pub. No.: US 2012/0068373 A1
(43) Pub. Date: Mar. 22, 2012

(54) IN AN INJECTION MOLDING MACHINE, A METHOD OF CONTROLLING AN UPSTREAM MELT PREPARATION DEVICE

(75) Inventors: Denise Davina Craig, Etobicoke (CA); Raymond Weiping Zhang, Brampton (CA); Kevin Wing Hang Leung, Toronto (CA)

(73) Assignee: Husky Injection Molding Systems Ltd., Bolton, ON (CA)

(21) Appl. No.: 13/320,993

(22) PCT Filed: Apr. 30, 2010
(86) PCT No.: PCT/CA2010/000642

§ 371 Date: Nov. 17, 2011

Related U.S. Application Data
(60) Provisional application No. 61/185,733, filed on Jun. 10, 2009.

(51) Int. Cl. B29C 45/78

(52) U.S. Cl. 264/40.6; 425/144

(57) ABSTRACT

A method (300, 400) of controlling a melt preparation device (102, 110) is provided. The melt preparation device (102, 110) is located upstream from a melt accumulator (122), the melt accumulator (122) and the melt preparation device (102, 110) being part of an injection unit (100) for preparing and injecting molding material and being associated with a target cycle time. The method (300, 400) comprises appreciating (310, 410) an operational parameter associated with the melt accumulator (122); appreciating (320, 420) a target performance indicator associated with operation of the injection unit (100); based on a comparison of the operational parameter to the target performance indicator, generating (330, 430) a control signal for controlling operation of the melt preparation device (102, 110), such that the melt preparation device (102, 110) prepares molding material in an amount sufficient to transfer to the melt accumulator (122) within an allocated portion of the target molding cycle time.

### TECHNICAL FIELD

The present invention generally relates to, but is not limited to molding of molded articles and more specifically, but not limited to, a method of controlling an upstream melt preparation device.

### BACKGROUND

Molding is a process by virtue of which a molded article can be formed from molding material (such as Polyethylene Teraphalate (PET), Polypropylene (PP) and the like) by using a molding system. Molding process (such as injection molding process) is used to produce various molded articles. One example of a molded article that can be formed, for example, from PET material is a preform that is capable of being subsequently blown into a beverage container, such as, a bottle and the like.

A typical injection molding system includes inter alia an injection unit, a clamp assembly and a mold assembly. The injection unit can be of a reciprocating screw type or of a two-stage type. Within the reciprocating screw type injection unit, raw material (such as PET pellets and the like) is fed through a hopper, which in turn feeds an inlet end of a plasticizing screw. The plasticizing screw is encapsulated in a barrel, which is heated by barrel heaters. Helical (or other) flights of the screw convey the raw material along an operational axis of the screw. Typically, a root diameter of the screw is progressively increased along the operational axis of the screw in a direction away from the inlet end.

As the raw material is being conveyed along the screw, it is sheared between the flights of the screw, the screw root and the inner surface of the barrel. The raw material is also subjected to some heat emitted by the barrel heaters and conducted through the barrel. As the shear level increases in line with the increasing root diameter, the raw material, gradually, turns into substantially homogenous melt. When a desired amount of the melt is accumulated in a space at discharge end of the screw (which is an opposite extreme of the screw vis-à-vis the inlet end), the screw is then forced forward (in a direction away from the inlet end thereof), forcing the desired amount of the melt into one or more molding cavities. Accordingly, it can be said that the screw performs two functions in the reciprocating type injection unit, namely (i) plasticizing of the raw material into a substantially homogeneous melt and (ii) injecting the substantially homogeneous melt into one or more molding cavities.

The two stage injection unit can be said to be substantially similar to the reciprocating type injection unit, other than the plasticizing and injection functions are separated. More specifically, an extruder screw, located in an extruder barrel, performs the plasticizing functions. Once a desired amount of the melt is accumulated, it is transferred into a melt accumulator, which is also sometimes referred in the industry as a “shooting pot”, the melt accumulator being equipped with an injection plunger, which performs the injection function.

U.S. Pat. No. 6,241,932 issued to Choi et al. on Jun. 5, 2001 discloses a method and system of operating a two stage injection molding machine wherein movement of the injection plunger in the shooting pot is coordinated with movement of the plasticizing screw and melt flow into the shooting pot such that the plunger provides minimal resistance to the melt flow into the shooting pot while avoiding the production of voids or air inside the melt. The undesired shear forces to which the melt is exposed are thus reduced, correspondingly reducing the melt degradation products which would otherwise result.

U.S. Pat. No. 6,514,440 to Kazmer, et al. issued on Feb. 4, 2003 discloses an injection molding apparatus, system and method in which the rate of material flow during the injection cycle is controlled. According to one preferred embodiment, a method of open-mold purging is provided in an injection molding system including a manifold to receive material injected from an injection molding machine. The method includes the steps of selecting a target purge pressure; injecting material from the injection molding machine into the manifold; and controlling the purge pressure to substantially track the target purge pressure, wherein the purge pressure is controllable independently from the injection molding machine pressure.

U.S. Pat. No. 4,311,446 to Hold et al. issued on Jan. 19, 1982; U.S. Pat. No. 4,094,940 to Hold on Jun. 13, 1978; U.S. Pat. No. 3,937,776 to Hold et al. on Feb. 10, 1976; and U.S. Pat. No. 3,870,445 to Hold et al. on Mar. 11, 1975 each teaches a method and apparatus for controlling the parameters of injection molding processes in a machine having a barrel with a plasticating chamber and a screw, rotatably and slidably disposed in said chamber, hopper means adjacent one end of said chamber communicating therewith and nozzle means disposed in the other end of said chamber communicating with a mold. Control of the injection molding process is achieved through an event recognition philosophy by sensing screw position, screw injection velocity, melt temperature, comparing the values at certain instances during the work cycle with known or desired values and using these values, changes of values and differences of values to monitor and initiate changes in the process parameters.

### SUMMARY

According to a first broad aspect of the present invention, there is provided a method of controlling a melt preparation device, the melt preparation device located upstream from a melt accumulator, the melt accumulator and the melt preparation device being part of an injection unit for preparing and injecting molding material and being associated with a target cycle time. The method comprises appreciating an operational parameter associated with the melt accumulator; appreciating a target performance indicator associated with operation of the injection unit; based on a comparison of the operational parameter to the target performance indicator, generating a control signal for controlling operation of the melt preparation device, such that the melt preparation device prepares molding material in an amount sufficient to transfer to the melt accumulator within an allocated portion of the target molding cycle time.

According to a second broad aspect of the present invention, there is provided a controller for controlling an injection unit for preparing and injecting molding material and being associated with a target cycle time, the injection unit including a melt preparation device, the melt preparation device located upstream from a melt accumulator. The controller is operable to appreciate an operational parameter associated with the melt accumulator; to appreciate a target performance indicator associated with operation of the injection unit; based on a comparison of the operational parameter to the target performance indicator, to generate a control signal for controlling operation of the melt preparation device, such that the melt preparation device prepares molding material in an amount sufficient to transfer to the melt accumulator within an allocated portion of the target molding cycle time.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 depicts a partially sectioned frontal view of an injection unit implemented according to a non-limited embodiment of the present invention.

FIG. 2 depicts a partially sectioned top view of the injection unit of FIG. 1.

FIG. 3 depicts a flow chart showing steps of a non-limiting embodiment of a method for controlling a melt preparation device of the injection unit of FIG. 1 and FIG. 2.

FIG. 4 depicts a flow chart showing steps of another non-limiting embodiment of a method for controlling a melt preparation device of the injection unit of FIG. 1 and FIG. 2.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

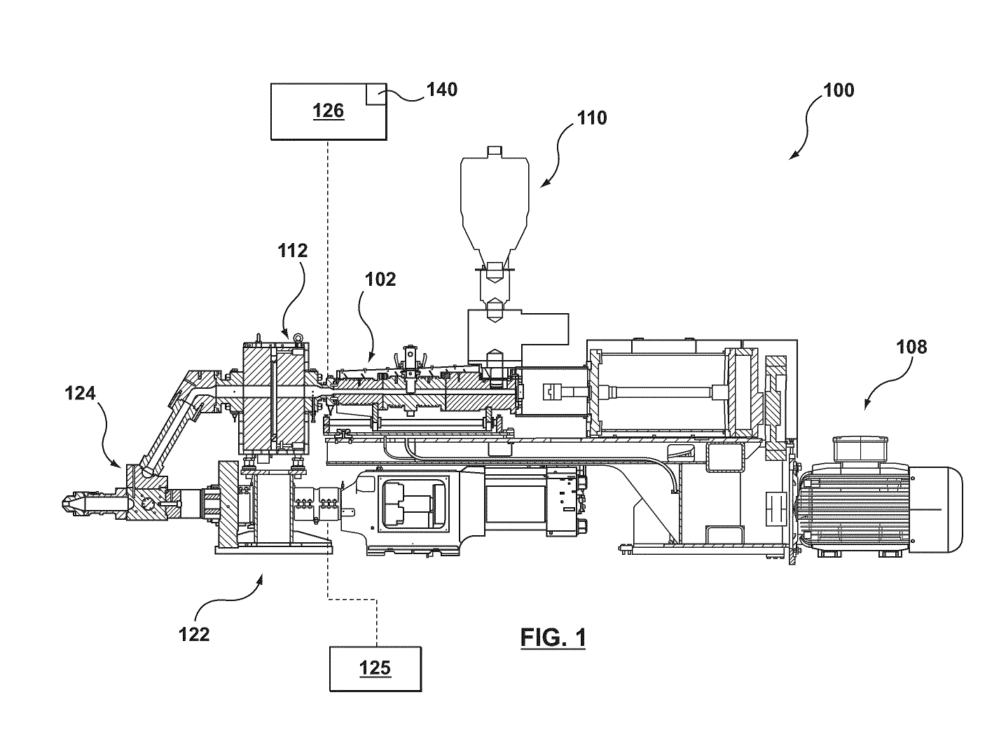

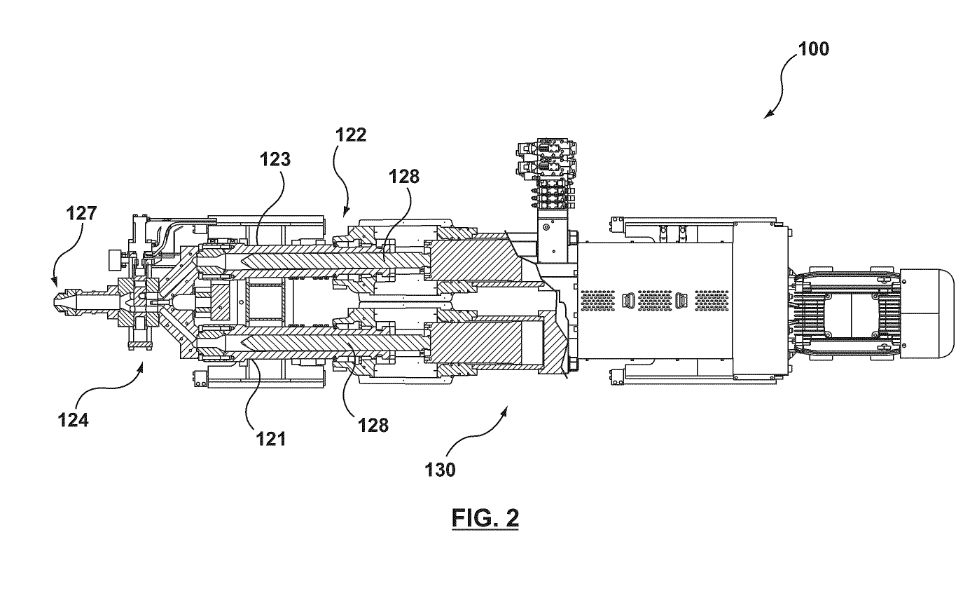

With reference to FIG. 1 and FIG. 2, an injection unit 100 implemented in accordance with non-limiting embodiments of the present invention, will now be described in greater detail, in which figures, FIG. 1 depicts a partially sectioned frontal view of the injection unit 100 and FIG. 2 depicts a partially sectioned top view of the injection unit 100.

Within the instantly illustrated embodiment, the injection unit 100 is of a two-stage type and to that extent, the injection unit 100 comprises an extruder 102 and a melt accumulator 122. The extruder 102 houses a screw (not depicted) for plasticizing raw material, as will be described in greater detail herein below. In some embodiments of the present invention, the extruder 102 can be implemented as a twin screw extruder and, to that end, the extruder 102 can house a set of two screws (not depicted). The extruder 102 (or to be more precise, the screw within the extruder 102) is actuated by a screw actuator 108. In the specific non-limiting embodiment of the present invention, the screw actuator 108 comprises an electric motor coupled to the extruder 102 via a gear box (not separately numbered); however, this need not be so in every embodiment of the present invention. As such, it should be appreciated that the screw actuator 108 can be implemented differently, such as a hydraulic actuator, a mechanical actuator or a combination thereof. It should be noted that in alternative non-limiting embodiments, the injection unit 100 can be implemented as a single-stage injection unit with a reciprocating screw.

In some embodiments of the present invention, the extruder 102 can operate in a continuous plasticizing manner (i.e. extruder 102 can be implemented as a continuous extruder). In other embodiments, the extruder 102 can operate in a near continuous plasticizing manner. In yet further embodiments, the extruder 102 can operate in an interrupted plasticizing manner (especially so, when the extruder 102 is implemented as a reciprocating-type unit).

In the specific non-limiting embodiment depicted herein, the screw actuator 108 imparts a rotational movement onto the screw of the extruder 102 and it is this rotational movement that performs a dual function: (a) plasticizing of the raw material and (b) transfer of the raw material into the melt accumulator 122, as will be described in greater detail herein below. As such, within this implementation, the screw of the extruder 102 is not associated with a reciprocal movement. In alternative embodiments, however, which are particularly applicable but not limited to scenarios where a single screw is employed in the extruder 102, the screw of the extruder 102 can be associated with the reciprocal movement, which can be imparted by the screw actuator 108 or by separate means (not depicted).

The injection unit 100 further includes a material feeder 110. The material feeder 110 is configured to supply raw material to the extruder 102. The material feeder 110 can be configured as a controlled (or metered) feeder or as a continuous feeder.

In a specific non-limiting embodiment of the present invention, the raw material is PET. In alternative embodiments, other materials or a mix of materials can be used. In a particular implementation of the embodiments of the present invention, the raw material includes a combination of virgin raw material and recycled raw material, in a particular proportion. The virgin raw material (which can come in a form of pellets, for example) and the recycled raw material (which can come in a form of flakes, for example) can be mixed at the material feeder 110 or at another upstream device (not depicted), such as a drier (not depicted), for example.

In a particular scenario, the raw material fed through the material feeder 110 may include 25% of the recycled raw material and 75% of the virgin raw material. In another particular scenario, the raw material may include 50% of the recycled raw material and 50% of the virgin raw material. In yet another particular scenario, the raw material may include 75% of the recycled raw material and 25% of the virgin raw material. Naturally, the exact combination of the raw material used can be different. It should be further noted that embodiments of the present invention can be applied to the injection unit 100 that processes only virgin raw material or only recycled raw material.

In addition to the material feeder 110, in some embodiments of the present invention, there may be provided an additive feeder (not depicted) for adding additional substances, such as for example colorants, acetaldehyde (AA) blockers and the like, to the extruder 102. Such additive feeders are well known in the art and, as such, will not be described here at any length.

There is also provided a filter 112, located fluidly in-between the extruder 102 and the melt accumulator 122. The purpose of the filter 112 is to filter impurities and other foreign matters from the plasticized material being transferred from the extruder 102 to the melt accumulator 122. It should be noted that in some embodiments of the present invention, which include but are not limited to scenarios where only virgin raw material is used, the filter 112 can be omitted. The specific implementation for the filter 112 is not specifically limited and, as an example, an off-the-shelf filter from Gneuss Inc. of Matthews, N.C. (www.gneuss.com) can be used to implement the filter 112.

Within the specific non-limiting embodiment being depicted herein, the melt accumulator 122 is implemented as a dual melt accumulator and to that extent the melt accumulator 122 can include two instances of the melt accumulator 122—a first melt accumulator 121 and a second melt accumulator 123, selectively fluidly coupled to the extruder 102, as will be described in greater detail herein below. In alternative non-limiting embodiments of the present invention, the melt accumulator 122 can include only a single instance of the melt accumulator 122.

Each of the first melt accumulator 121 and the second melt accumulator 123 includes an injection plunger 128 operatively disposed within the respective one of the first melt accumulator 121 and the second melt accumulator 123. The injection plunger 128 is actuated by a respective one of an injection plunger actuator 130, which in this particular embodiment of the present invention is implemented as a piston which actuates the injection plunger 128 via hydraulic means. However, in alternative non-limiting embodiments of the present invention, the injection plunger 128 can be actuated by a different type of an actuator (not depicted), such as mechanical actuator, electrical actuator and the like.

There is also provided a distribution assembly 124, located fluidly-in-between the extruder 102 and the melt accumulator 122, downstream from the filter 112. The distribution assembly 124 is implemented as a distribution valve and is configured to selectively fluidly connect:

(a) the extruder 102 to the first melt accumulator 121 while connecting the second melt accumulator 123 to a nozzle 127, which provides for fluid communication with a molding cavity (not depicted) either directly or via a melt distribution system (not depicted), such as a hot runner (not depicted) for enabling for melt transfer from the extruder 102 to the first melt accumulator 121 and melt injection from the second melt accumulator 123 into the molding cavity (not depicted) via the nozzle 127;
(b) the extruder 102 to the second melt accumulator 123 while connecting the first melt accumulator 121 to the nozzle 127, for enabling for melt transfer from the extruder 102 to the second melt accumulator 123 and melt injection from the first melt accumulator 121 into the molding cavity (not depicted) via the nozzle 127.

There is also provided a condition sensor, schematically depicted in FIG. 1, at 125. Generally speaking, the condition sensor 125 is configured to sense one or more operational parameters associated with operation of the injection unit 100. In embodiments of the present invention, the condition sensor 125 can be implemented as one or multiple condition sensors of the same type or of different types, as will be described in greater detail herein below.

In some embodiments of the present invention, the condition sensor 125 can be implemented as a position sensor associated with respective one of the two instances of the melt accumulator 122. Within this implementation the sensed condition comprises an indication of (a) a position and (b) speed associated with the respective one of the injection plunger 128 of the respective one of the first melt accumulator 121 and the second melt accumulator 123.

In other embodiments of the present invention, the condition sensor 125 can be implemented as a pressure sensor associated with respective one of the two instances of the melt accumulator 122. Within this implementation the sensed condition comprises an indication of pressure of a compressible fluid associated with the respective one of the injection plunger actuator 130. As such, the pressure of the compressible fluid can be that of oil used to actuate the respective one of the injection plunger actuator 130 or the molding material being transferred into the respective one of the first melt accumulator 121 and the second melt accumulator 123.

Naturally, other implementations for the condition sensor 125 are possible.

Also, provided within the architecture of FIG. 1 and FIG. 2 is a controller 126 (only depicted in FIG. 1 for the sake of simplicity). Controller 126 can be implemented as a general-purpose or purpose-specific computing apparatus that is configured to control one or more operations of the injection unit 100. It is also noted that the controller 126 can be a shared controller that controls operation of an injection molding machine (not depicted) that houses the injection unit 100 and/or other auxiliary equipment (not depicted) associated therewith.

Amongst numerous functions that can be controlled by the controller 126, some include (but are not limited to):
(i) Controlling the screw actuator 108 and more specifically the speed of rotation of the screw (not depicted) of the extruder 102;
(ii) Controlling the distribution assembly 124 for selectively implementing the melt transfer and melt injection switching between the two instances of the melt accumulator 122, as has been discussed above;
(iii) Controlling the material feeder 110, where the material feeder 110 is implemented as controlled feeder, also referred to sometimes by those of skill in the art as a volumetric feeder;
(iv) Controlling the above-mentioned additive feeder (not depicted) in those embodiments where such additive feeder is provided;
(v) Receiving sensed one or more operational parameters from the condition sensor 125;
(vi) Controlling other auxiliary equipment (not depicted), such as a dryer and the like;
(vii) Performing a cycle optimization routine configured to analyze and optimize different parameters of the molding cycle.

The controller 126 can comprise internal memory 140 configured to store one or more instructions for executing one or more routines. The internal memory 140 can also store and/or update various parameters, such as but not limited to:
(i) Indication of a target cycle time associated with the machine (not depicted) housing the injection unit 100;
(ii) Indication of a target speed and a target position, associated for example, with the injection plunger 128 for a given point in the molding cycle;
(iii) Indication of a target throughput for the transfer of molding material between the extruder 102 and the melt accumulator 122.
(iv) Set up parameters associated with the injection unit 100 or components thereof.

Given the architecture described with reference to FIG. 1 and FIG. 2, it is possible to execute a method for controlling a melt preparation device. Within embodiments of the present invention, the controller 126 can execute the method for controlling the melt preparation device. Within embodiments of the present invention, the melt preparation device can include the extruder 102. In alternative embodiments, the melt preparation device may include the material feeder 110. In yet alternative non-limiting embodiments, the melt preparation device may include the above-mentioned additive feeder (not depicted), as well as other auxiliary equipment located upstream from the melt accumulator 122, which other auxiliary equipment prepares melt and/or raw material to be plasticized (such as, for example, dryers, etc.). Naturally, in some embodiments of the present invention, the melt preparation device being controlled can include one or more devices listed immediately above.

### First Embodiments of a Method

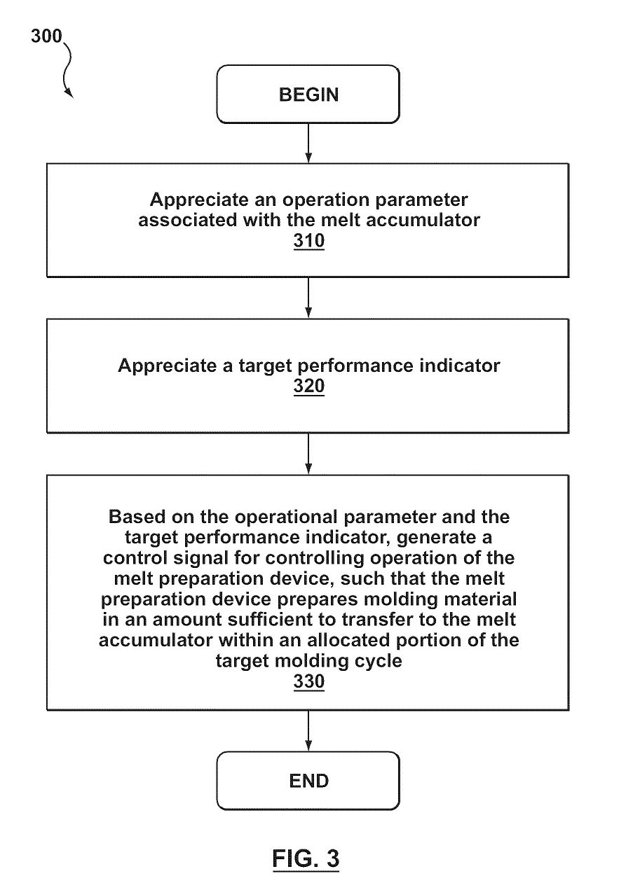

According to some embodiments of the present invention, the controller 126 can execute a method 300 (FIG. 3) for controlling a melt preparation device. Within these embodiments and for illustration purposes, it shall be assumed that:
(a) The extruder 102 is implemented as a continuous extruder;
(b) The material feeder 110 is implemented as a controlled feeder;
(c) The melt accumulator 122 comprises two instances of the melt accumulator 122—the first melt accumulator 121 and the second melt accumulator 123, as is depicted in FIG. 2;
(d) The condition sensor 125 is implemented as a position sensor associated with each of the respective once of the first melt accumulator 121 and the second melt accumulator 123.

### Step 310

The method 300 begins at step 310, where the controller 126 appreciates an operational parameter associated with the melt accumulator 122, such as for example, the first melt accumulator 121. In a particular example, the controller 126 receives, from the condition sensor 125, an indication of position and speed of the injection plunger 128 associated with the first melt accumulator 121.

### Step 320

The method 300 then proceeds to step 320, where the controller 126 appreciates a target performance indicator. In particular example, the controller 126 accesses the internal memory 140 and retrieves an indication of a target throughput of molding material to be transferred from the extruder 102 to the melt accumulator 122. The target throughput is indicative of a throughput required to transfer enough molding material into the melt accumulator 122 within a given period of time, i.e. an allocated portion of the target molding cycle (or, in other words, portion of the molding cycle allocated for plasticizing and transfer of the molding material for a given one of the first melt accumulator 121 and the second melt accumulator 123).

In some embodiments of the present invention, the indication of the target throughput can be stored in the internal memory 140 by an operator as part of a set-up process. In alternative non-limiting embodiments of the present invention, the indication of the target throughput can be a throughput parameter associated with a previous molding cycle sensed by the controller 126 and stored in the internal memory 140. In yet further non-limiting embodiments of the present invention, the indication of the target throughput can be generated and stored by a cycle optimization routine executed by the controller 126, the cycle optimization routine configured to analyze and optimize different parameters of the molding cycle, including the required target throughput.

### Step 330

The method 300 then proceeds to step 330, at which point the controller 126, based on the operational parameter and the target performance indicator, generates a control signal for controlling operation of the melt preparation device, such that the melt preparation device prepares molding material in an amount sufficient to transfer to the melt accumulator 122 within an allocated portion of the target molding cycle (or, in other words, portion of the molding cycle allocated for plasticizing and transfer of the molding material for a given one of the first melt accumulator 121 and the second melt accumulator 123).

In particular, the controller 126 first translates the position and the speed of the injection plunger 128 received as part of step 310 to an indication of a current throughput. In particular, based on the position and speed of the injection plunger 128, known melt density and surface area associated with the injection plunger 128, the controller 126 calculates the volume of the molding material being transferred. Based on the so-calculated volume, as well as based on the indication of the portion of the target molding allocated for molding material transfer, the controller 126 further determines the current throughput. The controller 126 then compares the current throughput to the target throughput obtained in step 320.

If the comparison renders a positive outcome or, in other words, if the current throughput matches the target throughput, as determined as part of step 330, and is therefore sufficient for achieving the required volume of molding material within the allocated portion of the target molding cycle, the method 300 loops back to step 310.

On the other hand, if the comparison renders a negative outcome or, in other words, if the current throughput does not match the target throughput, as determined as part of step 320 (for example, if the current throughput is lower than the target throughput) and therefore is insufficient for achieving the required volume of molding material within the allocated portion of the target molding cycle, the method 300 generates a control signal for controlling operation of the melt preparation device, such that the melt preparation device prepares molding material in an amount sufficient to transfer to the melt accumulator (122) within the allocated portion of the target molding cycle. In a particular implementation, the control signal is for controlling the speed of the extruder 102 and the feeding rate of the material feeder 110 to provide for more plasticized material based on the differential between the current throughput and the target throughput as determined as part of step 320.

By the same token, it is envisioned that if the current throughput does not match the target throughput, as determined as part of step 320 (for example, if the current throughput is higher than the target throughput), and therefore is too high for achieving the required volume of molding material within the target time, the method 300 generates a control signal for controlling operation of the melt preparation device, such that the melt preparation device prepares molding material in an amount sufficient to transfer to the melt accumulator (122) within the allocated portion of the target molding cycle. In particular implementation, the control signal is for controlling the speed of the extruder 102 and the material feeder 110 to provide for less plasticized material based on the differential between the current throughput and the target throughput determined as part of step 320.

Accordingly, it can be broadly said that within these embodiments of the present invention, the control signal is for causing at least one of the extruder 102 and the material feeder 110 to either increase or decrease output thereof based on the comparison of the current throughput and the target throughput. The control signal is then released towards the extruder 102 and the material feeder 110 and the method 300 loops back to step 410.

In some implementations of the present invention, as part of the execution of method 300, the controller 126 can compare the current speed of the injection plunger 128 (effectively, the sensed operation parameter) to the target speed of the injection plunger 128 (effectively, the target operational parameter). Within these embodiments, the speed of the injection plunger 128 is sensed as part of the operational parameter in step 310. Also, within these embodiments, the shot size and the cycle time are known. Accordingly, the controller 126 can determine if the current speed is sufficient for enough molding material for the shot size to transfer within the cycle time allocated for the transfer function and controls the melt preparation device accordingly.

### Second Embodiment of a Method

According to some embodiments of the present invention, the controller 126 can execute another variation of the method 300 for controlling the melt preparation device. Within these embodiments and for illustration purposes, it shall be assumed that:
(e) The extruder 102 is implemented as a continuous extruder;
(f) The material feeder 110 is implemented as an uncontrolled feeder;
(g) The melt accumulator 122 comprises two instances of the melt accumulator 122—the first melt accumulator 121 and the second melt accumulator 123, as is depicted in FIG. 2;
(h) The condition sensor 125 is implemented as a position sensor.

The method 300 can be executed substantially in the same manner as described above, other than during execution of step 330, the control signal can be for controlling only the speed of the extruder 102 (or, in other words, the material feeder 110 is not controlled). This alternative embodiment of the method 300 is particularly applicable, but not limited to those implementations, where the extruder 102 is implemented with a single instance of a screw (not depicted).

### Third Embodiment of a Method

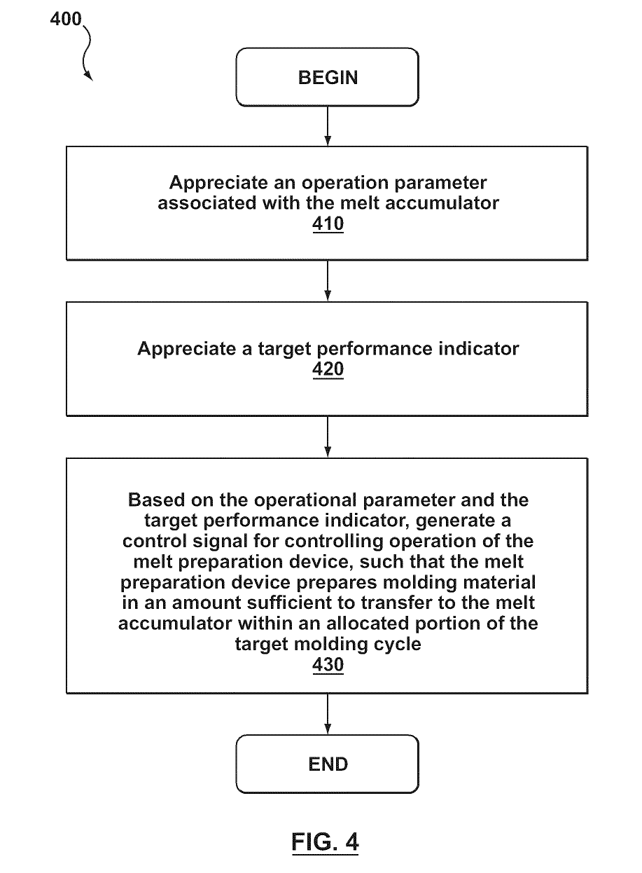

According to some embodiments of the present invention, the controller 126 can execute a method 400 (FIG. 4) for controlling a melt preparation device. Within these embodiments and for illustration purposes, it shall be assumed that:
(a) The extruder 102 is implemented as a continuous extruder;
(b) The material feeder 110 is implemented as an uncontrolled feeder;
(c) The melt accumulator 122 comprises two instances of the melt accumulator 122—the first melt accumulator 121 and the second melt accumulator 123, as is depicted in FIG. 2;
(d) The condition sensor 125 is implemented as a pressure sensor.

### Step 410

The method 400 starts at step 410, where the controller 126 appreciates an operational parameter associated with the melt accumulator 122. In a particular example, the controller 126 receives, from the condition sensor 125, an indication of pressure and temperature of a compressible fluid (such as oil) associated with the injection plunger actuator 130.

### Step 420

The method 400 then proceeds to step 420, where the controller 126 appreciates a target performance indicator. In particular example, the controller 126 accesses the internal memory 140 and retrieves an indication of a target throughput of molding material to be transferred from the extruder 102 to the melt accumulator 122. The target throughput is indicative of a throughput required to transfer enough molding material into the melt accumulator 122 within a given period of time, i.e. an allocated portion of the target molding cycle (or, in other words, portion of the molding cycle allocated for plasticizing and transfer of the molding material for a given one of the first melt accumulator 121 and the second melt accumulator 123)

In some embodiments of the present invention, the indication of the target throughput can be stored in the internal memory 140 by an operator as part of a set-up process. In alternative non-limiting embodiments of the present invention, the indication of the target throughput can be a throughput parameter associated with a previous molding cycle sensed by the controller 126 and stored in the internal memory 140. In yet further non-limiting embodiments of the present invention, the indication of the target throughput can be generated and stored by a cycle optimization routine executed by the controller 126, the cycle optimization routine configured to analyze and optimize different parameters of the molding cycle, including the required target throughput.

### Step 430

The method 400 then proceeds to step 430, at which point the controller 126, based on the operational parameter, generates a control signal for controlling operation of the melt preparation device, such that the melt preparation device prepares molding material in an amount sufficient to transfer to the melt accumulator 122 within an allocated portion of the target molding cycle (or, in other words, portion of the molding cycle allocated for plasticizing and transfer of the molding material for a given one of the first melt accumulator 121 and the second melt accumulator 123).

In particular, the controller 126 first converts the sensed pressure of the compressible fluid to a value representative of the volume compressed using PVT (Pressure-Volume-Temperature) equation. Using the PVT equation, the controller 126 determines, based on the pressure and the temperature of the compressible fluid, the volume of the compressible fluid. Based on the so-determined volume of the compressible fluid and the allocated portion of the target molding cycle, the controller 126 determines the current throughput.

The controller 126 then compares the so-determined current throughput to the target throughput. The remainder of step 430 is executed substantially similar to execution of step 330.

In additional embodiments of the present invention, the operational parameter can include pressure of the molding material measured as it is transferred to the melt accumulator 122. Within those embodiments, the pressure of the molding material being transferred is converted into throughput similar to the process described above in respect to the oil pressure and is then compared with a target throughput.

In additional embodiments of the present invention, the operational parameter can be a difference between a reading from a first sensor and a second sensor, such as a first proximity switch and a second proximity switch. In those embodiments of the present invention, the target performance indicator indicates a target difference of time between the two sensors to ensure that sufficient molding material is prepared. Within these embodiments of the present invention, the throughput is calculated based on how much time it takes for the injection plunger 128 to reach a certain position within the melt accumulator 122.

In a variation of method 300, 400, the control signal can be for controlling (in addition to and/or instead of the material feeder 110 and/or in addition to and/or instead of the extruder 102) the aforementioned additive feeder (not depicted) and/or other melt preparation devices location upstream from the melt accumulator 122.

In some embodiments of the present invention, the controller 126 executes the method 300, 400 each molding cycle. In other embodiments of the present invention, the controller 126 executes the method 300, 400 at a start up of the molding system. In yet further embodiments of the present invention, the controller 126 executes the method 300, 400 at a given point in each molding cycle. In yet further embodiments of the present invention, the controller 126 executes the method 300, 400 in a continuous over a portion or the whole of a molding cycle.

A technical effect of embodiments of the present invention includes provision of controlled and repeatable filling of the melt accumulator 122 based, for example, on real-time (or near-real time) comparison of actual operational parameters with target performance indicators. Another technical effect of embodiments of the present invention may include a simplified implementation of melt preparation devices and other upstream devices, such as for example ability to use devices with less precision. Another technical effect of embodiments of the present invention may include ability to accommodate changes in bulk density of the raw material, slippage, etc. Yet another technical effect of embodiments of the present invention may include decreased overall cost of the system, for example, due to use of less-precise upstream equipment. It should be expressly understood that not each and every technical effect, in its entirety, has or can be realized in each and every embodiment of the present invention.

The description of the embodiments provides examples of the present invention, and these examples do not limit the scope of the present invention. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A method (300, 400) of controlling a melt preparation device (102, 110), the melt preparation device (102, 110) located upstream from a melt accumulator (122), the melt accumulator (122) and the melt preparation device (102, 110) being part of an injection unit (100) for preparing and injecting molding material and being associated with a target cycle time, the method (300, 400) comprising:
appreciating (310, 410) an operational parameter associated with the melt accumulator (122);
appreciating (320, 420) a target performance indicator associated with operation of the injection unit (100);
based on a comparison of the operational parameter to the target performance indicator, generating (330, 430) a control signal for controlling operation of the melt preparation device (102, 110), such that the melt preparation device (102, 110) prepares molding material in an amount sufficient to transfer to the melt accumulator (122) within an allocated portion of the target cycle time.

2. The method (300, 400) of claim 1, wherein said appreciating (310, 410) comprises receiving an indication of the operational parameter from a condition sensor (125).

3. The method (300) of claim 2, wherein said condition sensor (125) comprises a position and speed sensor associated with an injection plunger (128) of the melt accumulator (122).

4. The method (400) of claim 2, wherein said condition sensor (125) comprises a pressure sensor associated with an injection plunger actuator (130) of an injection plunger (128).

5. The method (300, 400) of claim 1, wherein said operational parameter comprises at least one of:
(i) position associated with an injection plunger (128) of the melt accumulator (122);
(ii) speed associated with the injection plunger (128) of the melt accumulator (122); and
(iii) oil pressure associated with an injection plunger actuator (130) of the injection plunger (128); and
(iv) melt pressure associated with the molding material being transferred into the melt accumulator (122).

6. The method (300, 400) of claim 1, wherein said target performance indicator comprises one of
(i) a target throughput associated with an injection plunger (128) of the melt accumulator (122);
(ii) a target speed associated with the injection plunger (128) as the molding material is being transferred into the melt accumulator (122).

7. The method (300, 400) of claim 1, wherein the melt preparation device (102, 110) comprises an extruder (102).

8. The method (300, 400) of claim 1, wherein the melt preparation device (102, 110) comprises one of an extruder (102) and a material feeder (110).

9. The method (300, 400) of claim 1, wherein
the melt preparation device (102, 110) comprises an extruder (102) and a material feeder (110); and wherein
said control signal is for causing at least one of the extruder (102) and the material feeder (110) to either increase or decrease output thereof.

10. The method (300) of claim 1, wherein said operational parameter comprises an indication of a position and a speed associated with an injection plunger (128) of the melt accumulator (122); and wherein the target performance indicator comprises a target throughput; and wherein the method (300, 400) further comprises:
based on the position and the speed, determining a current throughput; and
comparing the current throughput to the target throughput.

11. The method (300) of claim 10, wherein said determining the current throughput is further based on melt density and surface area associated with the injection plunger (128).

12. A controller (126) for controlling an injection unit (100) for preparing and injecting molding material and being associated with a target cycle time, the injection unit (100) including a melt preparation device (102, 110), the melt preparation device (102, 110) located upstream from a melt accumulator (122), the controller (126) being operable:
to appreciate an operational parameter associated with the melt accumulator (122);
to appreciate (320, 420) a target performance indicator associated with operation of the injection unit (100);
based on a comparison of the operational parameter to the target performance indicator, to generate a control signal for controlling operation of the melt preparation device (102, 110), such that the melt preparation device (102, 110) prepares molding material in an amount sufficient to transfer to the melt accumulator (122) within an allocated portion of the target cycle time.
